(19) United States
(12) Patent Application Publication
(10) Pub. No.: US 2022/0250275 A1
(43) Pub. Date: Aug. 11, 2022

(54) ROTATING BODY CLOTH MOULD AND METHOD FOR PREPARING ARTIFICIAL STONE PATTERN BOARD BY USING IT

(71) Applicants: Jinpan Chen, Foshan (CN); Weifeng Lu, Foshan (CN)

(72) Inventors: Jinpan Chen, Foshan (CN); Weifeng Lu, Foshan (CN)

(21) Appl. No.: 17/197,074

(22) Filed: Mar. 10, 2021

(30) Foreign Application Priority Data
Feb. 5, 2021 (CN) 202110160843.8

(51) Int. Cl. B28B 3/12; B28B 7/00

(52) U.S. Cl. CPC B28B 3/12; B28B 7/007

(57) ABSTRACT

The invention discloses a concave-convex rotating body cloth mould, comprising a hollow cylinder, wherein the outer surface of the hollow cylinder is provided with grooves with gradually changing depths in the circumferential direction, and the groove is distributed with small air holes communicating with the inside of the hollow cylinder; one of the bottom surfaces of the hollow cylinder is provided with a compressed air inlet; the outer surface of the hollow cylinder is provided with an arc-shaped guide plate at intervals, and the guide plate is provided with powder and slurry spray nozzles; the above of the hollow cylinder is provided with a multicolor hopper; a rotating shaft is penetrated inside the hollow cylinder, and the rotating shaft is driven by a variable speed motor. The invention further discloses a method for preparing artificial boards. The artificial stone board prepared is realistic in effect, and has strong operability.

### BACKGROUND OF THE INVENTION

### 1. Field of the Invention

The invention relates to the field of artificial stone, in particular to a rotating body cloth mould and a method for preparing artificial stone pattern board.

### 2. Description of the Related Art

Artificial quartz stone is a new type of artificial stone made of quartz sand powder as the main filler, unsaturated polyester resin as the binder, with high-frequency vibration compression under vacuum, and solidification under medium temperature, which is a kind of environmental protection, green and new building materials and decoration materials with high hardness, with no radioactive pollution, and reusable. However, most of the quartz stone is particle board or simple flocculent board. Because there is no natural texture and color of marble, the grade of artificial quartz stone cannot be greatly improved. At present, there are pattern plates imitating natural marble at home and abroad, but the color is relatively dull, the texture is unnatural, the degree of simulation is extremely low, and there is no beauty of natural marble.

On the other hand, the existing artificial stone imitation marble pattern production method is: prefabricate plastic or rubber pattern moulds and masking moulds using the lines pattern made according to needs, and then align the pattern mould with the lines pattern and place it on the paving board; spread the mixture all over the other parts except the pattern mould, pre-press the cylinder roller press to compact the mixture; take out the pattern mould, and prepare a prefabricated sheet with a hollow pattern; the hollow pattern is provided with a main pattern and outwardly extending fine patterns; the hollow pattern is consistent with the lines pattern. Then put on the masking mould and put in other colors of base material. This method of making marble patterns is restricted by the cumbersome operation of the flat plastic rubber mould and the covering mould, the service life is not long, the manual color filling is unstable, and it is not easy to operate.

Therefore, a technology that can overcome the above shortcomings remains to be proposed.

### SUMMARY OF THE INVENTION

In view of the above problems, the invention proposes a rotating cloth mould with simple operation, realistic and three-dimensional pattern effect. By using this mould and cooperating with the method proposed by the invention, the production efficiency is greatly improved and human participation factors are reduced.

The technical solutions of the invention are:

a concave-convex rotating body cloth mould, comprising a hollow cylinder, wherein the outer surface of the hollow cylinder is provided with grooves with gradually changing depths in the circumferential direction, and the groove is distributed with small air holes communicating with the inside of the hollow cylinder; one of the bottom surfaces of the hollow cylinder is provided with a compressed air inlet; the outer surface of the hollow cylinder is provided with an arc-shaped guide plate at intervals, and the guide plate is provided with powder and slurry spray nozzles; the above of the hollow cylinder is provided with a multicolor hopper; a rotating shaft is penetrated inside the hollow cylinder, and the rotating shaft is driven by a variable speed motor.

Further, the multicolor hopper is provided with at least three blanking pipes, and the lower end of the blanking pipe is close to the guide plate.

Further, one end of the rotating shaft is provided with a gear, and the gear is in shaft connection with the variable speed motor.

Further, the guide plate is close to the outer surface of the hollow cylinder; the powder and slurry spray nozzle is provided to be several.

Further, the depth of the groove is 3-30 mm; the wall thickness of the hollow cylinder is 40-60 mm; the diameter of the small air hole is 0.5-2 mm; the thickness of the guide plate is 20-30 mm.

The invention further provides another technical solution:

a method for preparing artificial stone pattern board by using the concave-convex rotating body cloth mould above, comprising the following steps:

1) carving grooves of different depths on the surface of the hollow cylinder according to the predetermined design;

2) dropping the mixed artificial stone resin sand material of the same or different colors from the discharge pipe of the multicolor hopper to the arc-shaped guide plate, and automatically spraying powder or spraying slurry or spraying powder and spraying slurry at different spraying nozzles simultaneously;

3) with the rotation of the cloth mould, the guide plate presses the material on the surface of the hollow cylinder; through the rotation, the powder and slurry form a pattern with a certain trend, thereby forming stripes and patterns in the material layer; through the high and low or staggered distribution of the blocks and strips formed by the grooves, an artificial stone pattern board with a strong three-dimensionality is obtained;

4) running the cloth mould with a 10 cm-330 cm track at 5 cm on the paving board covered with artificial stone mixed raw materials; when the lowest part of the hollow cylinder passes directly above the paving board, the material of the groove pattern attached to the cloth mould falls off under the action of gravity and internally loaded micro air pressure to form a certain shape or pattern on the paving board;

5) spreading another layer of artificial stone mixed raw materials on the paving board, vacuumizing and vibrating to press, and heating and solidifying to moulding; then, after being kept flat and curing for a period of time, polishing to obtain an artificial stone pattern board with abundant coarse and fine lines and partitioned patterns on the surface.

Further, in step 4), in order to achieve multicolor cloth at the same time and multicolor interval cloth, the wrapping film can be used to wrap and cover the filler to achieve partitioned cloth and local patterns.

The advantages of the invention compared with the prior art are:

the invention provides a rotating body concave-convex cloth mould that integrates the preparation of the aggregate layer shape and the spraying powder to form the material layer stripes. It sprays the color pink paste into the material layer while pressing out the pattern groove shape, and rotates to complete the scraping and pattern generation actions. The advantages are:

1) there is no need for shielding plates and flat plastic rubber moulds, and the transition color zone is more natural and closer to the natural stone effect;

2) the degree of environmental protection and automation is high, the patterns are more realistic, the labor intensity of workers is reduced, the time of workers in the working area is greatly shortened, and the damage to the sense of smell caused by smelling of workers is reduced;

3) partitioned cloth is realized, and each cloth can achieve independent and cross cloth; combined with the squeezing and scraping effect of the multicolor blanking hopper and the guide plate, layered cloth can be realized; shapes and heights formed by different grooves vary, and it is combined with powder and slurry spraying, so the 3D effect is stronger;

4) the invention has fast pattern making speed, the pattern material extrusion, stacking and powder spraying process are integrated, and the position is accurate, which overcomes the shortcomings of cumbersome operation of traditional flat plastic rubber moulds and covering moulds, low service life, and unstable manual color filling.

### BRIEF DESCRIPTION OF THE DRAWINGS

FIG. 1 is an effect diagram of the coarse and fine textured and medium textured artificial quartz produced by Embodiment 2 of the invention;

FIG. 2 is a cross-sectional view of the mould in Embodiment 1 of the invention.

### DETAILED DESCRIPTION OF THE PREFERRED EMBODIMENTS

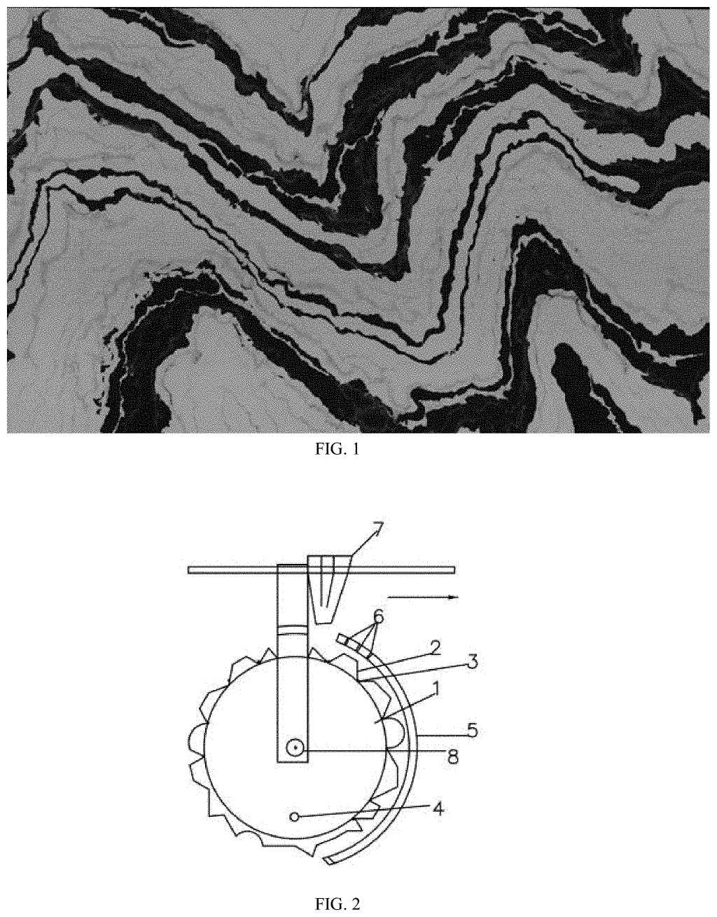

The invention will be further described in detail hereinafter with reference to FIG. 1 and FIG. 2.

### Embodiment 1

In the embodiment, an installation and manufacturing process of a concave-convex rotating body cloth mould is proposed: first, prepare a silicone rubber hollow cylinder 1, with a diameter of 1050 mm, a length of 1700 mm, and a wall thickness of 50 mm. Open a compressed air inlet 4 on one of the bottom surfaces of the silicone rubber hollow cylinder 1, and carve the concave and convex grooves 2 on the silicone rubber hollow cylinder 1 according to the pre-designed pattern and layering requirements; the depth of the grooves 2 includes four types: 10 mm, 15 mm, 20 mm, and 30 mm. The groove 2 is distributed with small air holes 3 communicating with the inside of the hollow cylinder 1, the diameter of which is 1 mm. One of the bottom surfaces of the hollow cylinder 1 is provided with a compressed air inlet 4. The side of the hollow cylinder 1 is provided with an arc-shaped guide plate 5, the thickness of which is 30 mm. The guide plate 5 is provided with several powder and slurry spray nozzles 6. The above of the hollow cylinder 1 is provided with a multicolor hopper 7. The hollow cylinder 1 is supported by a rotating shaft 8 and is connected to a variable speed motor that drives it to rotate through a gear connected to the rotating shaft 8.

### Embodiment 2

In the embodiment, a method for preparing artificial stone with fine coarse and fine textures and medium textures is proposed.

1) Weighing the raw materials according to the weight ratio.

Material A: 54% quartz sand, 30% quartz powder, 13% unsaturated polyester resin, 1.1% medium temperature curing agent, 1.0% coupling agent and 0.9% composite color paste A.

Material B: 55% quartz sand, 29% quartz powder, 12.8% unsaturated polyester resin, 1.2% medium temperature curing agent, 1.0% coupling agent and 1.0% composite color paste B.

Material C: 56% quartz sand, 29.5% quartz powder, 11.2% unsaturated polyester resin, 1.0% medium temperature curing agent, 0.8% coupling agent and 1.5% composite color paste C.

2) Adding the composite color paste, unsaturated polyester resin, tert-butyl peroxy-2-ethylhexanoate, and γ-methacryloxypropyl trimethoxysilane corresponding to materials A, B, and C into the resin mixing tank and stirring evenly, and then pouring it into a mixer containing pre-mixed quartz sand and quartz powder; following the sequence of 15 Hz low frequency forward rotation for 2 minutes, 15 Hz low frequency reverse rotation for 2 minutes, 45 Hz high frequency forward rotation for 3 minutes, and 45 Hz high frequency reverse rotation for 3 minutes; stirring and mixing for 10 minutes;

3) adding materials A, B, and C into the different channels of the multicolor hopper 7, and then dropping onto the hollow cylinder 1, and at the same time spraying the slurry and the color powder at the powder and slurry spray nozzle 6 respectively; through the squeezing and rotating action of the arc-shaped guide plate 5 and the hollow cylinder 1, the sprayed color slurry and color powder form a certain pattern in the interior and surface of the material, and are pressed on the groove 2;

4) when the hollow cylinder 1 slowly translates in the horizontal direction while maintaining the state of rotation, and in the condition that the material squeezed on the groove 2 in step 3) reaches the lowest point, the small air holes 3 on the groove 2 are acted on by the force of gravity and the micro air pressure applied inside, so that the cloth block on the groove 2 falls off to the iron plate;

5) after the operation completes one revolution, paving the remaining A, B, and C materials;

6) feeding the cloth pattern mixture with coarse and fine textures and medium textures in step 5) into the press and vacuumizing, vibrating at high frequency according to 8 frequency bands, namely, 25 Hz 40 seconds, 30 Hz 30 seconds, 36 Hz 30 seconds, 40 Hz 30 seconds, 44 Hz 60 seconds, and 50 Hz 30 seconds, to obtain a formed artificial stone pattern board;

7) putting the artificial stone pattern board in the curing oven, and after curing for 120 minutes at 85° C., laying flat for moulding for 24 hours;

8) performing fine polishing with a grinding block of 26-6000 mesh to obtain an artificial stone board with coarse and fine textures and medium textures. Refer to FIG. 1 for details.

Through the verification of production practice, it can be known that the method used in the invention to produce artificial stone boards with coarse and fine textures and medium textures is stable in production, and has the advantages of high degree of automation, fine textures, clear, natural, and beautiful.

The invention and the embodiments thereof are described hereinabove, and this description is not restrictive. What is shown in the drawings is only one of the embodiments of the invention, and the actual structure is not limited thereto. All in all, structural modes and embodiments similar to the technical solution of the invention without deviating from the inventive purpose of the invention made by those of ordinary skill in the art without creative design shall all fall within the protection scope of the invention.

1. A concave-convex rotating body cloth mould, comprising a hollow cylinder, wherein the outer surface of the hollow cylinder is provided with grooves with gradually changing depths in the circumferential direction, and the groove is distributed with small air holes communicating with the inside of the hollow cylinder; one of the bottom surfaces of the hollow cylinder is provided with a compressed air inlet; the outer surface of the hollow cylinder is provided with an arc-shaped guide plate at intervals, and the guide plate is provided with powder and slurry spray nozzles; the above of the hollow cylinder is provided with a multicolor hopper; a rotating shaft is penetrated inside the hollow cylinder, and the rotating shaft is driven by a variable speed motor.

2. The concave-convex rotating body cloth mould according to claim 1, wherein the multicolor hopper is provided with at least three blanking pipes, and the lower end of the blanking pipe is close to the guide plate.

3. The concave-convex rotating body cloth mould according to claim 1, wherein one end of the rotating shaft is provided with a gear, and the gear is in shaft connection with the variable speed motor.

4. The concave-convex rotating body cloth mould according to claim 1, wherein the guide plate is close to the outer surface of the hollow cylinder; the powder and slurry spray nozzle is provided to be several.

5. The concave-convex rotating body cloth mould according to claim 1, wherein the depth of the groove is 3-30 mm; the wall thickness of the hollow cylinder is 40-60 mm; the diameter of the small air hole is 0.5-2 mm; the thickness of the guide plate is 20-30 mm.

6. A method for preparing artificial stone pattern board by using the concave-convex rotating body cloth mould, comprising the following steps:
1) carving grooves of different depths on the surface of the hollow cylinder according to the predetermined design;
2) dropping the mixed artificial stone resin sand material of the same or different colors from the discharge pipe of the multicolor hopper to the arc-shaped guide plate, and automatically spraying powder or spraying slurry or spraying powder and spraying slurry at different spraying nozzles simultaneously;
3) with the rotation of the cloth mould, the guide plate presses the material on the surface of the hollow cylinder; through the rotation, the powder and slurry form a pattern with a certain trend, thereby forming stripes and patterns in the material layer; through the high and low or staggered distribution of the blocks and strips formed by the grooves, an artificial stone pattern board with a strong three-dimensionality is obtained;
4) running the cloth mould with a 10 cm-330 cm track at 5 cm on the paving board covered with artificial stone mixed raw materials; when the lowest part of the hollow cylinder passes directly above the paving board, the material of the groove pattern attached to the cloth mould falls off under the action of gravity and internally loaded micro air pressure to form a certain shape or pattern on the paving board;
5) spreading another layer of artificial stone mixed raw materials on the paving board, vacuumizing and vibrating to press, and heating and solidifying to moulding; then, after being kept flat and curing for a period of time, polishing to obtain an artificial stone pattern board with abundant coarse and fine lines and partitioned patterns on the surface.

7. The method for preparing artificial stone pattern board according to claim 6, wherein in step 4), in order to achieve multicolor cloth at the same time and multicolor interval cloth, the wrapping film can be used to wrap and cover the filler to achieve partitioned cloth and local patterns.
